(19) United States
(12) Patent Application Publication
(10) Pub. No.: US 2025/0128641 A1
(43) Pub. Date: Apr. 24, 2025

(54) PRE-CHARGE BATTERY ELECTRICAL SYSTEM FROM DISCRETE BATTERY STRINGS

(71) Applicant: Caterpillar Inc., Peoria, IL (US)

(72) Inventors: Timothy Beetler, Peoria, IL (US); Jose D. Miranda, Peoria, IL (US)

(73) Assignee: Caterpillar Inc., Peoria, IL (US)

(21) Appl. No.: 18/490,957

(22) Filed: Oct. 20, 2023

(51) Int. Cl. B60L 58/18; B60L 53/20; H01M 10/46; H01M 10/48; H01M 50/204; H01M 50/51; H02J 7/00

(52) U.S. Cl. CPC B60L 58/18; B60L 53/20; H01M 10/46; H01M 10/482; H01M 50/204; H01M 50/51; H02J 7/0013; H02J 7/0047; H02J 7/0069; B60L 2200/40; B60L 2210/10; B60L 2240/547; H01M 2220/20; H02J 2207/20

(57) ABSTRACT

A battery system includes a load bus to connect to a DC link, a single pre-charge circuit connected to the load bus, multiple battery packs, and a control circuit. Each battery pack includes multiple battery strings that include battery cells connected in series, a positive contactor to connect the battery string to the load bus, and a pre-charge contactor to connect the battery string to the pre-charge circuit. The control circuit selects a battery string to pre-charge the DC link, closes the pre-charge contactor of the battery string to connect the selected battery string to the pre-charge circuit, and opens the pre-charge contactor of the selected battery string to disconnect the battery string from the pre-charge circuit and close the positive contactor of the selected battery string to connect the battery string to the load bus when the DC link is pre-charged.

### TECHNICAL FIELD

This document relates to rechargeable battery technology and in particular to techniques of activating multiple battery packs in parallel to power large moving work machines.

### BACKGROUND

Powering a large moving work machine (e.g., a wheel loader) with an electric motor requires a large mobile electric energy source that can provide current of tens to hundreds of Amperes (Amps). Multiple large capacity battery cells connected in parallel as battery strings can provide the sustained energy power needed by a large electric-powered moving work machine. However, when multiple battery strings are connected in parallel, it is necessary to avoid connecting battery cells immediately to—a direct current (DC) link and its capacitance. Doing so may result in high inrush currents that can potentially damage the batteries and components of the work machine.

### SUMMARY OF THE INVENTION

Electric powered large moving work machines use large capacity battery systems. A large capacity battery system should be brought online safely.

An example battery system includes a load bus to connect to a DC link, a single pre-charge circuit connected to the load bus, multiple battery packs, and a control circuit. Each battery pack includes multiple battery strings that include multiple battery cells connected in series, a positive contactor to connect the battery string to the load bus, and a pre-charge contactor to connect the battery string to the pre-charge circuit. The control circuit is configured to select a battery string to pre-charge the DC link, closes the pre-charge contactor of the battery string to connect the selected battery string to the pre-charge circuit, and opens the pre-charge contactor of the selected battery string to disconnect the battery string from the pre-charge circuit and close the positive contactor of the selected battery string to connect the battery string to the load bus when the DC link is pre-charged.

### BRIEF DESCRIPTION OF THE DRAWINGS

FIG. 1 is an elevation view depicting an example work machine in accordance with this disclosure.

FIG. 2 is a block diagram of a modular battery system for a work machine in accordance with this disclosure.

FIG. 3 is a circuit diagram of an example of a battery pack of a modular battery system in accordance with this disclosure.

FIG. 4 is a flow diagram of an example of a method of pre-charging a DC link when connecting to a modular battery system in accordance with this disclosure.

### DETAILED DESCRIPTION

Examples according to this disclosure are directed to methods and systems for automatically bringing a large capacity battery system online safely. Large capacity battery systems can be used in electric work machines for example, and the battery system is connected to a direct current (DC) to alternating current (AC) converter by a DC link, and the DC-AC converter is connected to the electric drive system of a moving work machine. The DC link includes a large capacitance. Connecting a large capacity battery system to an uncharged DC link capacitance can result in large inrush currents that could damage the battery cells, the interconnecting electric cables of the battery system, and the components of the electric drive system.

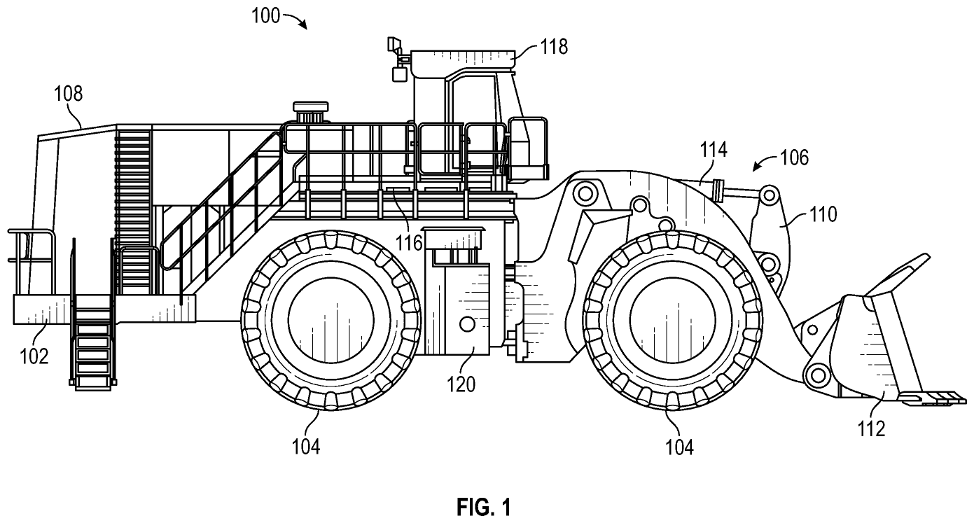

FIG. 1 depicts an example machine 100 in accordance with this disclosure. In FIG. 1, machine 100 includes frame 102, wheels 104, implement 106, and a speed control system implemented in one or more on-board electronic devices like, for example, an electronic control unit or ECU. Example machine 100 is a wheel loader. In other examples, however, the machine may be other types of machines related to various industries, including, as examples, construction, agriculture, forestry, transportation, material handling, waste management, and so on. Accordingly, although a number of examples are described with reference to a wheel loader machine, examples according to this disclosure are also applicable to other types of machines including graders, scrapers, dozers, excavators, compactors, material haulers like dump trucks, along with other example machine types.

Machine 100 includes frame 102 mounted on four wheels 104, although, in other examples, the machine could have more than four wheels. Frame 102 is configured to support and/or mount one or more components of machine 100. For example, machine 100 includes enclosure 108 coupled to frame 102. Enclosure 108 can house, among other components, an electric motor to propel the machine over various terrain via wheels 104. In some examples, multiple electric motors are included in multiple enclosures at multiple locations of the machine 100.

Machine 100 includes implement 106 coupled to the frame 102 through linkage assembly 110, which is configured to be actuated to articulate bucket 112 of implement 106. Bucket 112 of implement 106 may be configured to transfer material such as, soil or debris, from one location to another. Linkage assembly 110 can include one or more cylinders 114 configured to be actuated hydraulically or pneumatically, for example, to articulate bucket 112. For example, linkage assembly 110 can be actuated by cylinders 114 to raise and lower and/or rotate bucket 112 relative to frame 102 of machine 100.

Platform 116 is coupled to frame 102 and provides access to various locations on machine 100 for operational and/or maintenance purposes. Machine 100 also includes an operator cabin 118, which can be open or enclosed and may be accessed via platform 116. Operator cabin 118 may include one or more control devices (not shown) such as, a joystick, a steering wheel, pedals, levers, buttons, switches, among other examples. The control devices are configured to enable the operator to control machine 100 and/or the implement 106. Operator cabin 118 may also include an operator interface such as, a display device, a sound source, a light source, or a combination thereof.

Machine 100 can be used in a variety of industrial, construction, commercial or other applications. Machine 100 can be operated by an operator in operator cabin 118. The operator can, for example, drive machine 100 to and from various locations on a work site and can also pick up and deposit loads of material using bucket 112 of implement 106. As an example, machine 100 can be used to excavate a portion of a work site by actuating cylinders 114 to articulate bucket 112 via linkage assembly 110 to dig into and remove dirt, rock, sand, etc. from a portion of the work site and deposit this load in another location.

Machine 100 can include a battery compartment connected to frame 102 and including a battery system 120. Battery system 120 is electrically coupled to the one or more electric motors of the machine 100.

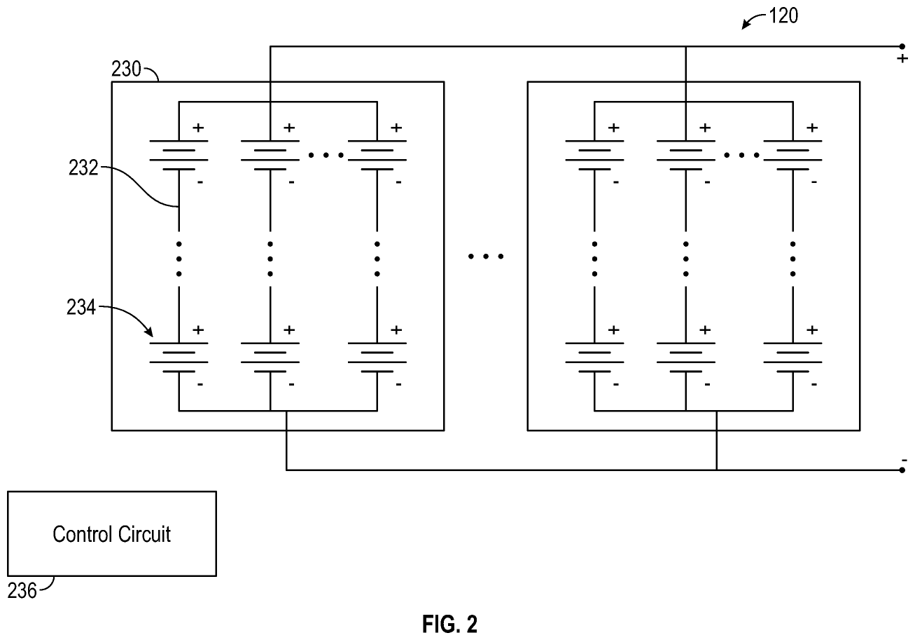

FIG. 2 is a block diagram of a modular battery system. The battery system 120 can be used to provide power to a machine, such as the example machine 100 of FIG. 1. The battery system 120 includes multiple battery packs 230 (e.g., two to eight battery packs). Each battery pack 230 includes multiple battery strings 232 (e.g., two to five battery strings). Each battery string 232 includes multiple large capacity batteries 234 connected in series (e.g., two to twelve 58 Volt, 80 Amp-hour batteries or 60 kilowatt-hour batteries).

The battery system 120 includes a control circuit 250 to bring the battery strings 232 and the battery packs 230 online in a discharge state to provide electrical energy to a work machine and a charge state to recharge the batteries. The control circuit 250 may include processing circuitry that includes logic to perform the functions described. The processing circuitry may include a microprocessor, application specific integrated circuit (ASIC), programmable gate array (PGA), or other type of processor, interpreting or executing instructions in software or firmware. In some examples, the control circuit 250 includes a logic sequencer circuit. A logic sequencer refers to a state machine or other circuit that sequentially steps through a fixed series of steps to perform the functions described. A logic sequencer circuit can be implemented using hardware, firmware, or software.

The DC link of a connection to a work machine may have a large capacitance (e.g., 26,000 microfarads). To connect the battery system 120 to such a large capacitive load, the capacitance of the DC link is pre-charged to avoid creating large inrush currents that may potentially damage components of the battery system 120 and components of the electric work machine.

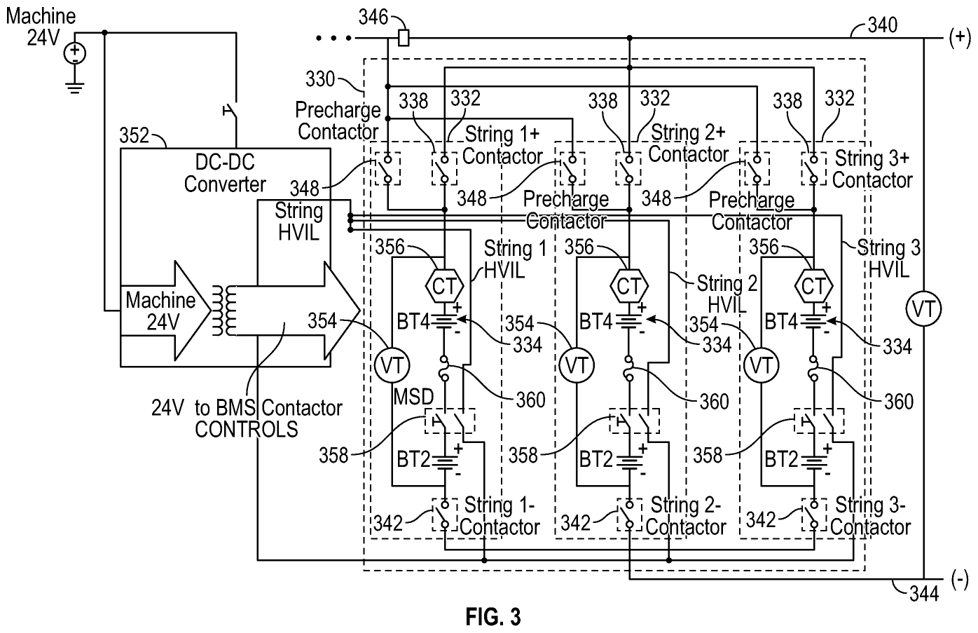

FIG. 3 is a circuit diagram of an example of a battery pack 330 of a modular battery system. The battery system 120 may include many battery packs 330 connectable in parallel to a load bus 340 that is connected to the DC link of a connection to an electric work machine. The battery pack 330 in the example of FIG. 3 includes three battery strings 332 that each include multiple large capacity battery cells 334 connected in series. Each battery string 332 includes a positive contactor 338 to connect the positive end of the battery string 332 to the load bus 340. The battery strings 332 are connectable in parallel to the load bus 340. Each battery string 332 includes a negative contactor 342 to connect the negative end of the battery string 332 to a negative load bus 344.

The battery system 120 includes one pre-charge circuit 346 connected to the load bus 340. In pre-charging, energy to pre-charge the DC link is provided by one battery string 332 being connected to the pre-charge circuit 346. The capacitance of the DC link is pre-charged to approximately the voltage of the battery string 332. The selected battery string 332 is connected to the pre-charge circuit 346 and the DC link is pre-charged by the selected battery string 332 through the pre-charge circuit 346. The pre-charge circuit 346 slows the charging of the capacitance of the DC link to slow inrush current when the selected battery string 332 is connected to the DC link. Any battery string 332 of any battery pack 330 of the battery system 120 is connectable to the pre-charge circuit 346 to pre-charge the DC link.

The pre-charge circuit 346 may include a pre-charge resistance. The pre-charge resistance (e.g., multiple resistors) and the load capacitance form a time constant for the pre-charging. In some examples, the pre-charge circuit 346 includes multiple positive temperature coefficient (PTC) thermistors. The PTC thermistors increase resistance of the pre-charge circuit 346 with increase in temperature that may occur with increasing inrush currents to further limit inrush currents. The pre-charge circuit 346 may be rated to 100 Amperes or greater.

Each battery string 332 of the battery system 120 includes a pre-charge contactor 348 to connect the battery string 332 to the pre-charge circuit 346. Contactors are activated or closed by the control circuit 250 of the battery system. The control circuit 250 may connect any battery string 332 of the battery system to the pre-charge circuit 346 and connect any battery string 332 to the load bus 340 (and positive side of the DC link) and negative load bus 344 (and negative side of the DC link). The battery system may include an isolated direct-current-to-direct-current (DC-DC) converter connected to the pre-charge contactors 348, positive contactors 338, and negative contactors 342. The DC-DC converter 352 provides a voltage to close pre-charge contactors 348, positive contactors 338, and negative contactors 342 when activated by the control circuit 250. The DC-DC converter 352 provides isolation in the event of contactor failure. For instance, a contactor can be an electromechanical switching device that includes a coil to implement the switching. In the event of a contactor failure that shorts the high voltage connection of the contactor to the lower voltage coil, the DC-DC converter may prevent the high voltage from contacting the low voltage side of the system.

The battery strings 332 may include voltage measurement circuits 354 and current measurements circuits 356 used by the control circuit 250 to monitor the battery strings 332. The battery strings 332 may include a string disable circuit 358 used by the control circuit 250 to disable one or both of the positive contactor 338 and negative contactor 342 of a battery string 332 based on the monitored voltage or current of the battery string 332. The battery strings 332 may include a fuse 360.

Because the battery system 120 is modular, less battery packs 330 can be connected in parallel to the load bus 340 for smaller battery systems, and more battery packs 330 can be connected in parallel for larger battery systems. The control circuit 250 of the battery system 120 is responsible for bringing the battery system through the pre-charge phase and then bringing the battery strings 332 online to fully drive the load.

### INDUSTRIAL APPLICABILITY

In an example of bringing a modular battery system for a work machine online according to this disclosure, the battery packs 330 and battery strings 332 of the battery system 120 should be brought online in a safe manner. The control circuit 236 may select one battery string 332 of any battery pack 330 to perform a pre-charge process to pre-charge the load to approximately the voltage of the selected battery string to prevent large inrush currents from damaging the components of the battery system 120 and load. The control circuit 250 may start the pre-charge process in response to a command received to bring the battery system online in a discharge state to drive the load.

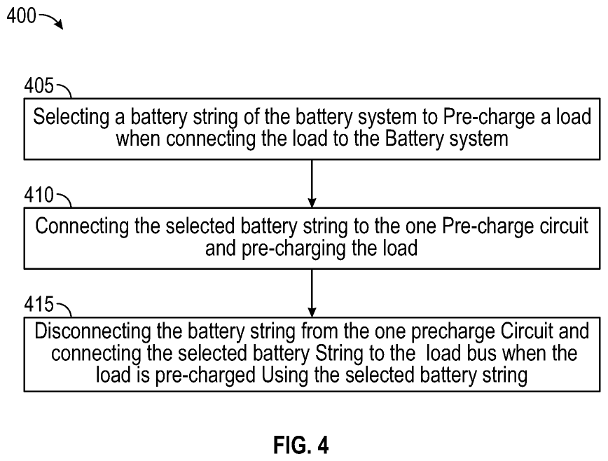

FIG. 4 is a flow diagram of an example of a method 400 of operating a battery system 120 that includes multiple battery packs 330 connectable in parallel to a load bus 340. Each battery pack 330 includes multiple battery strings 332 connectable in parallel to the load bus 340. The battery system 120 includes one pre-charge circuit 346 connected to the load bus 340. The method 400 may be performed by the control circuit 250 of the battery system.

At block 405, the control circuit 250 selects a battery string 332 of the battery system 120 to pre-charge a load when connecting the load to the battery system 120. The control circuit 250 may determine offline voltages of the battery strings using the voltage measurement circuits 354 and select a battery string 332 with the highest offline voltage to pre-charge the load when all the battery strings are disconnected from the load bus 340. The control circuit 250 may exclude a battery string 332 from being used for pre-charging the load when the voltage of the battery string 332 has an offline voltage different from offline voltages of the other battery strings by more than a threshold voltage difference. The control circuit 250 may exclude a battery string 332 from being used to drive the load when the offline voltage of the battery string 332 is different from offline voltages of the other battery strings by more than the threshold voltage difference.

At block 410, the control circuit 250 connects the selected battery string 332 to the single pre-charge circuit 346 of the battery system 120 and pre-charges the load. To connect the battery string 332 to the pre-charge circuit 346, the control circuit 250 closes the pre-charge contactor 348 of the battery string 332. The battery string 332 may include the single pre-charge contactor 348 on the positive side of the battery string and a negative contactor 342 on the negative end of the battery string 332. The control circuit 250 may also close both the pre-charge contactor 348 and the negative contactor 342 to connect the battery string 332 to the pre-charge circuit 346.

Any battery string from any battery pack 330 can be connected to the pre-charge circuit 346. This means that if the control circuit 250 determines that a selected battery string is unable or otherwise not suitable to pre-charge the load (e.g., based on measured voltage or current of the battery string 332), the control circuit 250 may select a different battery string from a different battery pack to connect to the pre-charge circuit 346.

At block 415, when the load is pre-charged, the control circuit 250 disconnects the battery string 332 from the pre-charge circuit 346 and connects the selected battery string 332 directly to the load bus 340. The control circuit 250 may connect the selected battery string 332 to the load bus 340 by opening the pre-charge contactor 348 of the battery string 332 and closing the positive contactor 338 of the battery string 332 when the load is pre-charged. The control circuit 250 closes the positive contactors 338 of the other battery strings 332 of the battery pack 330 that includes the selected battery string 332 when the load is pre-charged using the selected battery string. In this way the control circuit 250 brings the battery pack 330 online when the load is pre-charged.

The other battery packs may be brought online with the battery pack 330 of the selected battery string or may be selectively brought online. The control circuit 250 may connect the other battery strings 332 of the other battery packs 330 at the same time or bring the other battery packs 330 online in turn (e.g., based on the measured offline voltage of the battery packs 330). The control logic of the control circuit 250 supervises the activation of the large capacity battery cells 334 to protect against large inrush currents despite the complex multiple bus structure.

The above detailed description is intended to be illustrative, and not restrictive. The scope of the disclosure should, therefore, be determined with references to the appended claims, along with the full scope of equivalents to which such claims are entitled.

What is claimed is:

1. A battery system comprising:
a load bus to connect to a direct current (DC) link;
a single pre-charge circuit connected to the load bus;
multiple battery packs, each battery pack including multiple battery strings connectable to the load bus and the pre-charge circuit, wherein a battery string includes:
multiple battery cells connected in series;
a positive contactor to connect the battery string to the load bus; and
a pre-charge contactor to connect the battery string to the pre-charge circuit; and
a control circuit configured to:
select a battery string to pre-charge a DC link when the DC link is connected to the load bus;
close the pre-charge contactor of the battery string to connect the selected battery string to the pre-charge circuit; and
open the pre-charge contactor of the selected battery string to disconnect the battery string from the pre-charge circuit and close the positive contactor of the selected battery string to connect the battery string to the load bus when the DC link is pre-charged.

2. The battery system of claim 1,
wherein each battery string includes a voltage measurement circuit configured to measure the voltage of the battery string; and
wherein the control circuit is configured to select the battery string with a highest offline voltage to connect to the pre-charge circuit.

3. The battery system of claim 1, wherein the control circuit is configured to:
open the pre-charge contactor of selected battery string to disconnect the selected battery string from the pre-charge circuit when determining that the selected battery string is unable to pre-charge the DC link; and
close a pre-charge contactor of a different string of a different battery pack to pre-charge the DC link.

4. The battery system of claim 1,
wherein each battery string includes a negative contactor to connect the battery string to a negative load bus; and
wherein the control circuit is configured to close the pre-charge contactor and the negative contactor of the selected battery string to connect the selected battery string to the pre-charge circuit.

5. The battery system of claim 1,
wherein each battery string includes a voltage measurement circuit configured to measure the voltage of the battery string; and
wherein the control circuit is configured to not select a battery string to pre-charge the DC link when an offline voltage of the battery string is different from offline voltages of other battery strings by more than a threshold voltage difference.

6. The battery system of claim 1, wherein the pre-charge circuit includes a pre-charge resistance connected directly to the load bus without a contactor.

7. The battery system of claim 1, wherein the pre-charge circuit includes multiple positive temperature coefficient (PTC) thermistors.

8. The system of claim 1, wherein the pre-charge circuit is rated to 100 Amperes or greater.

9. The system of claim 1,
wherein each battery string includes a negative contactor to connect the battery string to a negative load bus; and
wherein the control circuit is configured to close the positive contactors and negative contactors of other battery strings of a battery pack that includes the selected battery string when the load is pre-charged using the selected battery string.

10. The system of claim 1, including:
an isolated direct current to direct current (DC-DC) converter connected to the pre-charge contactors and positive contactors and configured to provide a voltage to close the pre-charge contactors and positive contactors when activated by the control circuit.

11. A method of operating a battery system having one pre-charge circuit connected to a load bus and multiple battery packs, and each battery pack including multiple battery strings of multiple battery cells connected in series, the method comprising:
selecting a battery string of the battery system to pre-charge a DC link when connecting the battery system to the DC link;
connecting the selected battery string to the one pre-charge circuit and pre-charging the DC link; and
disconnecting the battery string from the one pre-charge circuit and connecting the selected battery string to the load bus when the DC link is pre-charged using the selected battery string.

12. The method of claim 11, wherein the selecting the battery string includes selecting the battery string with a highest offline voltage from among the multiple battery packs to connect to the one pre-charge circuit when all the battery strings are disconnected from the load bus.

13. The method of claim 11,
wherein connecting the selected battery string to the one pre-charge circuit includes closing a pre-charge contactor of the selected battery string and closing a negative contactor to connect the selected battery string to a negative load bus; and
wherein connecting the selected battery string to the load bus includes opening the pre-charge contactor of the battery string and closing a positive contactor of the battery string.

14. The method of claim 13, including closing positive contactors of other battery strings of a battery pack that includes the selected battery string when the DC link is pre-charged using the selected battery string.

15. The method of claim 11,
wherein the connecting the selected battery string to the one pre-charge circuit includes connecting the selected battery to a plurality of positive temperature coefficient (PTC) thermistors.

16. The method of claim 11, including:
measuring an offline voltage of the battery strings of the multiple packs; and
excluding a battery string from the pre-charging of the DC link when the offline voltage of the battery string is different from offline voltages of other battery strings by more than a threshold voltage difference.

17. The method of claim 11, including:
determining by a battery system control circuit that the selected battery string is unable to pre-charge the DC link; and
connecting a different battery string from a different battery pack to the one pre-charge circuit.

18. A non-transitory computer-readable storage medium including instructions that, when performed by a hardware processor of a battery system including one pre-charge circuit and multiple battery packs that each include multiple battery strings, cause the battery system to perform operations comprising:
receiving a command to bring the battery system online in a discharge state;
selecting a battery string of the battery system to pre-charge a DC link;
connecting the selected battery string to the one pre-charge circuit and pre-charging the DC link; and
disconnecting the battery string from the one pre-charge circuit and connecting the selected battery string to a load bus when the DC link is pre-charged using the selected battery string.

19. The non-transitory computer-readable storage medium of claim 18, including instructions that cause the battery system to perform operations including:
connecting the selected battery string to the one pre-charge circuit by closing a pre-charge contactor of the selected battery string and closing a negative contactor of the selected battery string to connect the battery string to a negative load bus; and
connecting the selected battery string directly to the load bus by opening the pre-charge contactor of the battery string and closing a positive contactor of the battery string.

20. The non-transitory computer-readable storage medium of claim 18, including instructions that cause the battery system to perform operations including:
determining that the selected battery string is unable to pre-charge the DC link; and
connecting a different battery string from a different battery pack to the one pre-charge circuit.
